(19) United States
(12) Patent Application Publication
(10) Pub. No.: US 2025/0095092 A1
(43) Pub. Date: Mar. 20, 2025

(54) INTERACTIVE PUBLIC WELFARE DONATION SYSTEM

(71) Applicant: YI-HUEI WANG, Taipei City (TW)

(72) Inventor: YI-HUEI WANG, Taipei City (TW)

(21) Appl. No.: 18/732,627

(22) Filed: Jun. 4, 2024

(30) Foreign Application Priority Data
Sep. 20, 2023 (TW) 112135938

(51) Int. Cl. G06Q 50/22

(52) U.S. Cl. CPC G06Q 50/22

(57) ABSTRACT

The public welfare donation system includes a database, registration and authentication module, donation operation module, and distribution record module. The database stores a first member record and a first donation target. The registration and authentication module, signally connected to the database, receives a login request from a first user, and approves the login request if the login request matches the first member record. The donation operation module, signally connected to the registration and authentication module, produces a donation information from the first user. The distribution record module, signally connected to the donation operation module and the database, performs a cross-checking operation on the donation information against the first donation target, executes a public welfare donation to the first donation target based on the donation information if the cross-checking operation is successful, generates a donation record, and updates first member record with the donation record.

### BACKGROUND OF THE INVENTION

### (a) Technical Field of the Invention

The present invention generally relates to systems for donations, particularly to an interactive and incentive-based public welfare donation system.

### (b) Description of the Prior Art

In today's information-rich society, individuals and social welfare organizations dedicated to promoting public welfare strive to reach more audiences by developing websites and platforms. However, a myriad of these websites and platforms often gradually fall into obscurity or becoming deserted.

Moreover, due to the concentration of public welfare funds in larger charitable foundations, smaller charitable organizations struggle to survive. They face difficulties in fundraising, often falling short of their targets and having to bear heavy financial burdens themselves. This situation makes it challenging for them to continue their efforts in public welfare.

For the smaller charitable organizations, their main challenge arises out of the lack of trust. Therefore, an urgent goal for them is to create a public welfare platform that bridges the gap between “promoting public welfare” and “building trust,” turning it into a key ingredient to the social safety network. The hope is, by using this platform, to thoroughly improve the plight of public welfare, overcome barriers, address slow fundraising, and support those whose fundraising falls short of their ideal goals. This will enable the various charitable organizations to gather funds to continue their efforts in social welfare, which is the present invention's aspirations.

Furthermore, the present invention also like to address issues such as how to ensure transparency by publicly disclosing the flow of funds for each donation to guarantee that the donated funds reach the intended beneficiaries and that there are acknowledgments in return, as well as how to promptly disseminate successful donation information to demonstrate transparency and build trust, etc.

Therefore, improving the dilemma of public welfare donations and solving issues such as inefficient fundraising and transparent, traceable donation processes through an interactive public welfare donation system are the goals of the present invention.

### SUMMARY OF THE INVENTION

To obviate the above shortcomings, the present invention provides a public welfare donation system including a database, registration and authentication module, donation operation module, and distribution record module. The database stores a first member record and a first donation target. The registration and authentication module, signally connected to the database, receives a login request from a first user, and approves the login request if the login request matches the first member record. The donation operation module, signally connected to the registration and authentication module, produces a donation information from the first user. The distribution record module, signally connected to the donation operation module and the database, performs a cross-checking operation on the donation information against the first donation target, executes a public welfare donation to the first donation target based on the donation information if the cross-checking operation is successful, generates a donation record, and updates first member record with the donation record.

The public welfare donation system may further include a display statistics module signally connected to the distribution record module, which displays the donation records generated by the distribution record module, summarizes the public welfare donations, and displays a notification message when a first cumulative total of the public welfare donations reaches a specific threshold value.

The public welfare donation system may further include a verification module which audits the public welfare donations' execution and verifies the donation records to ensure proper implementation of the public welfare donation.

The display statistics module may further summarize a second cumulative total within the donation records generated by the distribution record module, transition the first user from an original identity recognition to a new identity recognition when the second cumulative total reaches a specific individual threshold value, and notify the first user through the notification message through an audiovisual or animated means, illustrating a journey of the first user from the original identity recognition to the new identity recognition.

As such, the public welfare donation system of the present invention may provide, for example, charitable donation options such as donating spare change from purchases, selling goods for charity, donating second-hand items, supporting education, aiding medical assistance for the underprivileged, etc. It can also integrate gaming elements to enhance donors' motivation and willingness to participate in donations.

Therefore, the advantages of the present invention include:
(1) providing a mechanism for donors to access their detailed donation records at any time;
(2) providing a public welfare platform that promptly announces and displays the progress of public welfare donations, with openness and transparency to allow public scrutiny; and
(3) providing a public welfare platform with diverse channels and donation methods, as well as incentives to stimulate willingness to donate and other effects.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a system architecture diagram showing a public welfare donation system according to an embodiment of the present invention.

FIG. 2 is a schematic diagram showing the content of a first donation target and a donation information of the public welfare donation system of FIG. 1.

FIG. 3 is a schematic diagram showing the content of another first donation target and donation information of the public welfare donation system of FIG. 1.

FIG. 4 a schematic diagram showing a display of a first charity sale of the public welfare donation system of FIG. 1.

FIG. 5 is a schematic diagram showing the content of yet another first donation target and donation information of the public welfare donation system of FIG. 1.

FIG. 6 is a schematic diagram showing a QR code of the public welfare donation system of FIG. 1 scanned by a first user.

FIG. 7 is a schematic diagram showing an interactive module of the public welfare donation system of FIG. 1 interacting with a first user.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The descriptions are from the perspective of a first user 1 who participates and operates public welfare donation systems according the embodiments of the present invention.

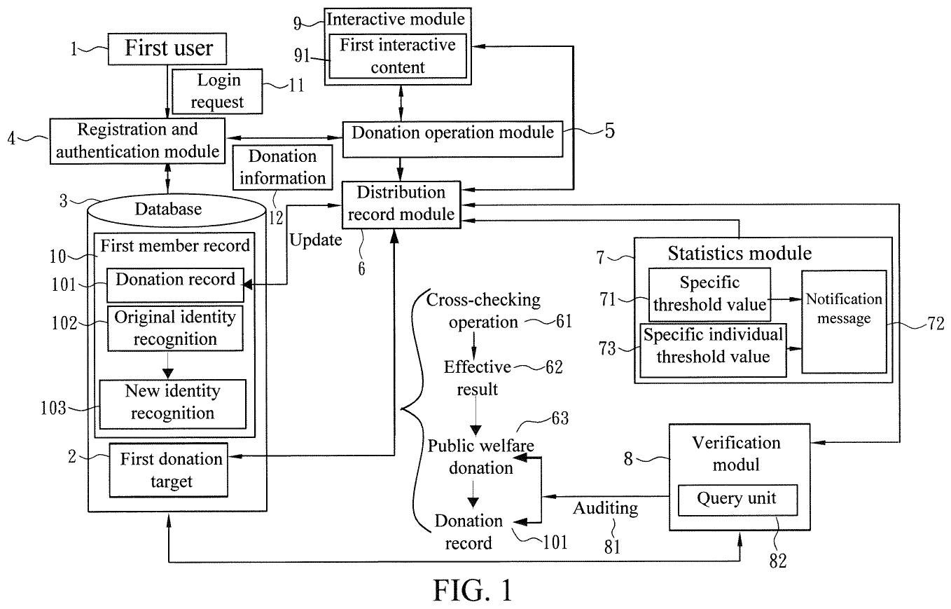

As shown in FIG. 1, when a first user 1 logs into a public welfare donation system according to an embodiment of the present invention, a registration and authentication module 4 will access the database 3, where it compares a login request 11 received from the first user 1 with an existing first member record 10 stored in the database 3 (including information such as the account ID and password entered by the first user 1 during registration). If they match, the login request 11 from the first user 1 is approved.

In the database 3, there are also records storing information about various charitable organizations (including their fund raising goals, case stories). After browsing these records in the public welfare donation system, the first user 1 selects an intended recipient (referred to as the first donation target 2), and fills in the details of the donation (such as donating 1000 dollars). A donation operation module 5 consolidates the recipient and donation details into a donation information 12 and sends the donation information 12 to a distribution record module 6, which is signally linked to the donation operation module 5 and the database 3. The distribution record module 6 performs a cross-checking operation 61 on the donation information 12 against the record of the first donation target 2. If the cross-checking is successful and the donation behavior is deemed valid, an effective result 62 is obtained. Subsequently, a public welfare donation 63 is executed based on the content of the donation information 12 to the first donation target 2. It should be pointed out that users of the public welfare donation system of the present invention can be those who have relevant donation needs (i.e., content uploaders and editors for the first donation target 2) or those donors (i.e., the first user 1) who browse the content of various donation needs within the system and choose their desired donation target. The public welfare donation 63, therefore, is subsequently accomplished based on the donation information 12.

The distribution record module 6 will also generates a donation record 101 for the first user 1 and updates this donation record 101 within the corresponding first member record 10 of the first user 1. Therefore, through this system, the first user 1 can, like checking a bank passbook, view their accumulated donation records 101 in their own first member record 10, thereby enjoying the convenience of instant access brought by this “public welfare passbook.”

Furthermore, the public welfare donation system of the present invention features diverse execution styles, illustrated by the following example:

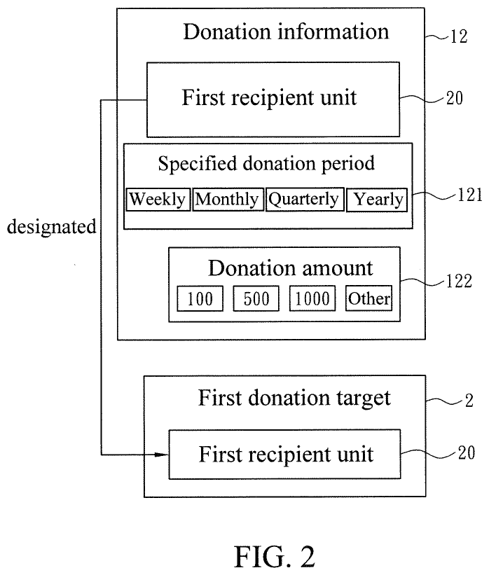

Periodic donation: As shown in FIGS. 1 and 2, the public welfare donation system of the present invention provides a mechanism for planned public welfare donations. Specifically, the first donation target 2's record contains information about a first recipient unit 20 (one of those organizations that are officially sanctioned or registered). The donation information 12 then includes information about the aforementioned first recipient unit 20 designated by the first user 1, a specified donation period 121 (such as weekly, monthly, quarterly, or yearly), and a donation amount 122 (selected or specified by the first user 1).

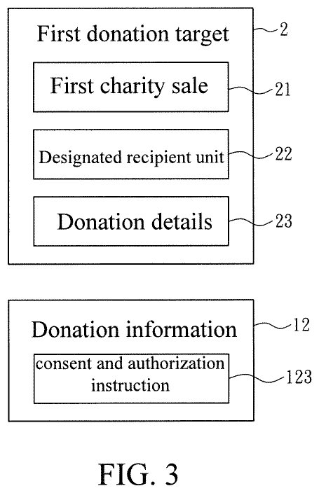

Charity sale: as shown in FIGS. 1, 3, and 4, the public welfare donation system of the present invention can provide a platform for individuals to list their own works (calligraphy, paintings, woodworking, food items, handmade goods, etc.), branded products (self-designed items), products from specific ethnic/groups/tribes or individuals with special identities (e.g., rehabilitated individuals, disabled individuals, vulnerable groups, indigenous people, etc.), or even second-hand items on the system for charity sale. Specifically, the record of the first donation target 2 contains information about a first charity sale 21 (including the charity items 211 such as indigenous handcrafted beadwork), a designated recipient unit 22 corresponding to the first charity sale 21 (for example, a charitable organization designated to receive a portion of the proceeds from the sale of this indigenous handcrafted beadwork), and donation details 23 (such as indicating that 35% of the proceeds from purchasing this handcrafted beadwork will be donated). Therefore, the public welfare donation system of the present invention allows users, when acting as providers of charity items 211, to set the price of charity items 211 (the content of the first charity sale 21), specify the percentage of proceeds to be donated (donation details 23), and designate charitable organizations to receive donations (designated recipient unit 22) when providing charity items 211. It also allows users, when acting as buyers of charity items 211, to complete the subsequent execution of public welfare donation 63 based on the donation information 12, which includes a consent and authorization instruction 123 for the aforementioned first donation target 2.

Disadvantaged student donation: As shown in FIGS. 1, 3, and 4, the public welfare donation system can provide a platform for stationery manufacturers to list stationery items for charitable sale (e.g., mechanical pencils, erasers, colored pens, etc., referred to as public welfare stationery 219) on the system for charitable sale. Specifically, the record of the first donation target 2 contains information about a first charity sale 21 (including public welfare stationery 219), a designated recipient unit 22 corresponding to the first charity sale 21 (such as financially disadvantaged students), and donation details 23 (such as indicating that proceeds from the sale of this public welfare stationery 219 will be used to provide stationery needed for financially disadvantaged students' education, or to provide scholarships to encourage their academic pursuits). Therefore, the public welfare donation system of the present invention allows stationery manufacturers, acting as users, to set the price of the public welfare stationery 219, specify the percentage of proceeds to be donated (donation details 23), and designate financially disadvantaged students to receive donations (designated recipient unit 22) when providing the public welfare stationery 219 for sale. It also allows users, acting as buyers of public welfare stationery 219, to complete the subsequent execution of public welfare donation 63 based on the donation information 12, which includes a consent and authorization instruction 123 for the aforementioned first donation target 2.

Underprivileged family donation: As shown in FIGS. 1, 3, and 4, the public welfare donation system of the present invention can provide a platform for manufacturers of maternal and child products or family assistance agencies to jointly sell charitable goods, which are listed on the system for charitable sale. Specifically, the record of the first donation target 2 contains information about a first charity sale 21 (including maternal and child products 210 such as baby bottles, diapers, etc.), a designated recipient unit 22 corresponding to the first charity sale 21 (such as single-parent families, women and children of domestic violence, etc.), and donation details 23 (such as indicating that proceeds from the purchase of these jointly sold maternal and child products 210 will be converted into assistance and protection funds for single-parent families, victims of domestic violence, etc.). Therefore, the public welfare donation system of the present invention allows manufacturers of maternal and child products or family assistance agencies, acting as users, to set the price of maternal and child products 210, specify the percentage of proceeds to be donated (donation details 23), and designate single-parent families, victims of domestic violence, etc. (designated recipient unit 22) to receive donations when providing maternal and child products 210 for charitable sale. It also allows users, acting as buyers of maternal and child products 210, to complete the subsequent execution of public welfare donation 63 based on the donation information 12 they fill out and send, which includes a consent and authorization instruction 123 for the aforementioned first donation target 2. This promotes the concept of maternal and child friendliness, providing a strong invisible umbrella of protection for single-parent families and victims of domestic violence.

Business donation: As depicted in FIGS. 1, 3, and 4, the public welfare donation system of the present invention can provide a mechanism to support charitable organizations to function as financially independent legal entities. Specifically, the first donation target 2 contains information about a first charity sale 21 (including activities such as car washes by the disadvantaged, massages by the visually impaired, etc., referred to as disadvantaged businesses 212), a designated recipient unit 22 corresponding to the first charity sale 21 (such as a specific massage studio for the visually impaired), and donation details 23 (such as funds raised for donation, intended to be invested in a specific public welfare project after deducting administrative costs and business operating costs). The donation information 12 includes a consent and authorization instruction 123 for the aforementioned first donation target 2.

Medical Donation: As depicted in FIGS. 1, 3, and 4, the public welfare donation system of the present invention can provide a project-based scheme such as one titled “Compassionate Medical Fundraising and Feedback,” which consists of two medical donation themes. One is for medical equipment needs (targeting institutions or long-term care facilities in underserved areas), and the other is for individuals (or families) unable to afford critical medical expenses. Specifically, the first donation target 2 contains information about a first charity sale 21 (including medical equipment 213 such as dialysis machines or funds for critical medical expenses 214), a designated recipient unit 22 corresponding to the first charity sale 21 (such as a clinic or long-term care facility in a remote area), and donation details 23 (such as long-term care institution's fundraising amount and the long-term care services provided by the recipient long-term care institution as feedback). The donation information 12 includes consent and authorization instructions 123 for the aforementioned first donation target 2. Furthermore, when a first user 1 logs into the public welfare donation system of the present invention and receives information about medical charity needs from the first donation target 2 (which can be posted by medical charity seekers who join the platform as members), they can understand from the information contained in the first donation target 2, such as a designated recipient unit 22 being a long-term care facility in a resource-limited remote area, that the beds, aids, wheelchairs, or diapers provided to the elderly residents may be outdated or severely lacking, requiring new purchases. However, the facility currently lacks funds for such purchases, and the donation details 23 specify the funding gap for purchasing the necessary items and the commitment to provide free accommodation or other benefits to economically disadvantaged elderly individuals. If the first user 1 agrees to this commitment, they can enter the donation amount and click on buttons such as “Agree to Donate,” sending the consent and authorization instructions 123 for the donation to the designated recipient unit 22, to the donation operation module 5 for subsequent donation operations. Additionally, the first user 1 can also learn from the information contained in the first donation target 2, such as a designated recipient unit 22 being a financially strained single-parent household mother, that she is suffering from cancer and unable to afford the hefty costs of chemotherapy and nutritional supplements. If the first user 1 agrees to donate to this medical expense project, they can enter the donation amount and click on buttons such as “Agree to Donate,” sending the consent and authorization instructions 123 for the donation to the designated recipient unit 22, to the donation operation module 5 for subsequent donation operations.

Disability Donation: As illustrated in FIGS. 1, 3, and 4, the public welfare donation system of the present invention can provide an assistance mechanism for economically disadvantaged individuals with disabilities. Specifically, the first donation target 2 includes a first charity sale 21 (comprising items such as equipment donations for disabled aids, monetary donations, or assistance projects for disabled individuals such as job matching opportunities 220), along with a designated recipient unit 22 corresponding to the first charity sale 21 (for example, a person with disabilities), and donation details 23 (such as sponsorship of assistive devices, sponsorship amount for purchasing assistive devices, provision of job opportunities, and other assistance conditions). The donation information 12 includes consent and authorization instructions 123 for the aforementioned first donation target 2.

Educational Aid Donation: As depicted in FIGS. 1, 3, and 4, the public welfare donation system of the present invention can provide a project-based educational aid loan mechanism for economically disadvantaged students who are unable to afford tuition fees. Specifically, the first donation target 2 includes a first charity sale 21 (comprising items such as student loans 215 for the tuition fees of the 113th academic year of a high school, etc.), along with a designated recipient unit 22 corresponding to the first charity sale 21 (for example, student John Doe attending a certain high school), and donation details 23 (including whether the receiving student needs to repay the loan, whether they are required to engage in charitable activities as feedback, and requirements for the student to obtain certifications, etc.). The donation information 12 includes consent and authorization instructions 123 for the aforementioned first donation target 2.

Athletic Aid Donation: As depicted in FIGS. 1, 3, and 4, the public welfare donation system of the present invention can provide a donation platform to support athletic talent, sports equipment, and the promotion of athletic programs. Specifically, the first donation target 2 includes a first charity sale 21 (comprising items such as funding for sports assistances 216 like the living expenses/tournament travel expenses of athletes, sports equipment, promotion of niche sports, etc.), along with a designated recipient unit 22 corresponding to the first charity sale 21 (for example, athletes in a specific sports field, baseball gloves for rural schools, promotion associations for niche sports, etc.), and donation details 23 (such as financial subsidies, physical equipment donations, jerseys, etc.). The donation information 12 includes consent and authorization instructions 123 for the aforementioned first donation target 2.

Material Donation: As depicted in FIGS. 1, 3, and 4, the public welfare donation system of the present invention can provide a platform for “material screening-matching needs” with the aim of promoting the values of cherishing resources and being friendly to the Earth. Specifically, the first donation target 2 includes a first charity sale 21 (comprising items such as idle items 217 like unused office desks, etc.), along with a designated recipient unit 22 corresponding to the first charity sale 21 (for example, the owner A of the office desk), and donation details 23 (for example, A is seeking a television set). Subsequently, a first user 1 with a need for an office desk and an unused television set can see the donation details 23 of the aforementioned first donation target 2 on this system, and then proceed to execute the public welfare donation 63 through the sending of donation information 12. This enables them to obtain the office desk from A and deliver the television set to A.

Consumption Donation: As depicted in FIGS. 1, 3, and 4, the public welfare donation system of the present invention can provide a platform for donating spare change without receiving change back. Specifically, the first donation target 2 includes a first charity sale 21 (which comprises items for consumption 218 like pastries sold by merchants affiliated with a public welfare foundation), along with a designated recipient unit 22 corresponding to the first charity sale 21 (for example, the public welfare foundation), and donation details 23 (such as the price of the pastries and the commitment to donate the leftover change to the public welfare foundation). The donation information 12 includes consent and authorization instructions 123 for the aforementioned first donation target 2.

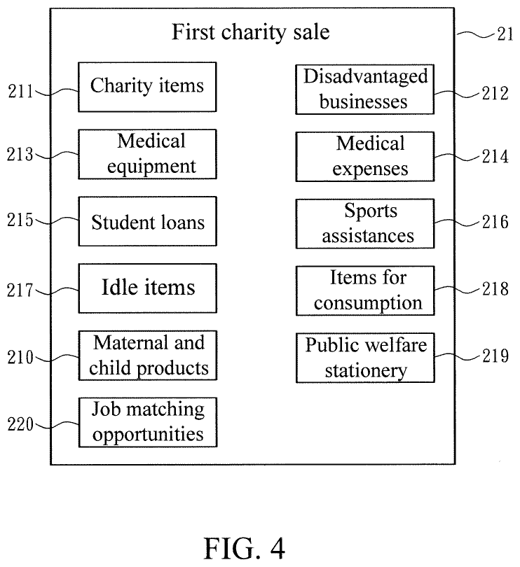

As shown in FIG. 4, therefore, the aforementioned charity sales, educational aid donations, underprivileged family donations, disability donations, business donations, medical donations, disadvantaged student donations, athletic aid donations, material donations, consumption donations, etc., related to the first charity sale 21, can be integrated into a graphical interface on this system. This interface includes menu options such as charity items 211, disadvantaged businesses 212, medical equipment 213, medical expenses 214, student loans 215, sports assistances 216, idle items 217, and consumption items 218, allowing the first user 1 to easily make selections at a glance.

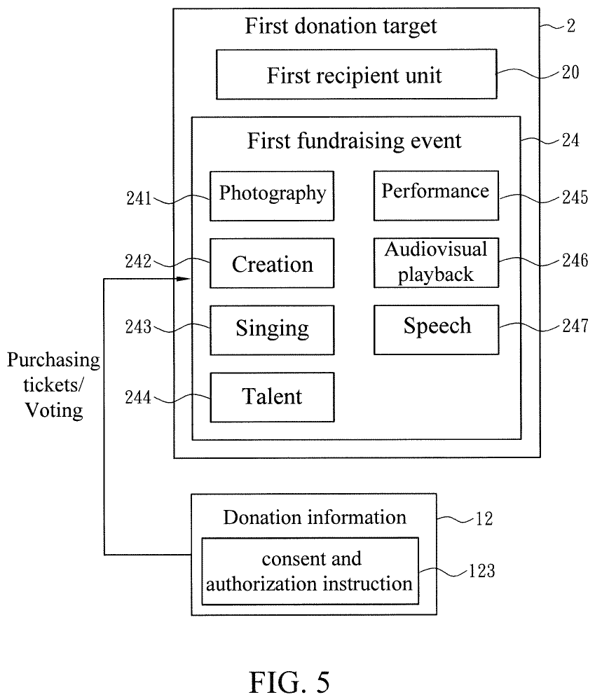

Activity Donation: As depicted in FIGS. 1 and 5, the public welfare donation system of the present invention can provide a platform for ticket donation and event fundraising. Specifically, the first donation target 2 includes information about a first recipient unit 20 (such as a public welfare foundation) and a first fundraising event 24. This first fundraising event 24 consists of at least one of the following events: photography 241, creation 242, singing 243, talent 244, performance 245, audiovisual playback 246, or speech 247. Taking singing 243 as an example, when this singing event is a concert by a famous band, the donation information 12 sent by the first user 1 includes purchasing tickets for this first fundraising event 24 (the concert of the famous band) and specifying that the fee for purchasing ticket be donated to the first recipient unit 20 (the public welfare foundation), etc., as indicated in the consent and authorization instruction 123 for the first donation target 2. However, when this singing event is conducted as a singing competition, the donation information 12 sent by the first user 1 includes voting for a specific participant in this first fundraising event 24 (singing competition). Each vote has a set price (such as 100 dollars per vote), and there is no limit to the number of votes. Therefore, when the first user 1 wants to support a particular participant, they purchase multiple votes and cast them for that participant. By accumulating the total amount of ticket purchases made in support of each participant, the system achieves the effect of fundraising. Additionally, the system can select participants with high vote counts to be honored as ambassadors for charity fundraising.

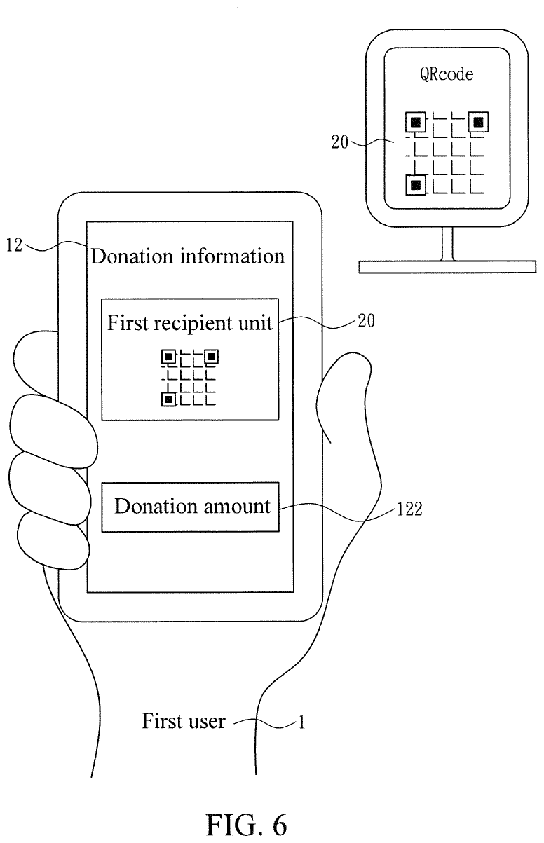

Real-time Donation: As depicted in FIGS. 1 and 6, the public welfare donation system of the present invention can provide a mechanism for instant donations, which can be set up at popular tourist attractions and affiliated stores to promote public welfare. Specifically, the first donation target 2 (such as a family support center) is presented to the first user 1 in the form of a coded barcode (such as the popular QR code) via a handheld device 13 (such as a smartphone). The first user 1 reads the information of the first recipient unit 20 (such as the donation bank account of the family support center) from the first donation target 2. The donation information 12 filled out by the first user 1 includes the first recipient unit 20 and a donation amount 122, and this donation information 12 is then sent back to the distribution record module 6 via the handheld device 13 for cross-checking operation 61 and subsequent execution of public welfare donation 63. Furthermore, the public welfare donation system of the present invention can put up its charitable sticker (containing QR code information of the first donation target 2) at the entrances of charity restaurants or shops that have signed cooperation agreements with charitable organizations. For example, using a poster-like presentation, when a donor (i.e., first user 1) is moved by the spirit of compassion and decides to scan the code, they will be directed to the donation homepage of the public welfare donation system of the present invention. At the same time, besides making a donation, the first user 1 can also obtain information such as the total amount of donations and the number of donations made on that day from the present invention system.

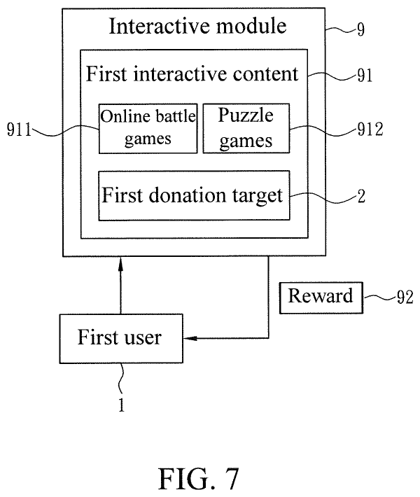

Game Donation: As depicted in FIGS. 1 and 7, the public welfare donation system of the present invention can provide an interactive module 9 (such as a game execution engine) that is signally connected to the donation operation module 5 and the distribution record module 6, allowing the first user 1 to participate (either for free or for a fee, with fees used for charitable purposes) in a first interactive content 91 (such as online battle games 911, puzzle games 912, etc.) bound to the first donation target 2 (i.e., a legally registered charitable organization). When the first user 1 participates in the first interactive content 91 and wins, they will receive at least one reward 92 (such as game points won from opponents in online battle games 911 or from puzzle games 912, or rewards earned after winning battles/completing levels), and they can donate these rewards through the distribution record module 6 based on the content of the donation information 12 (such as the amount or proportion of game points authorized by the first user 1 for donation), thereby executing public welfare donation 63 for the first donation target 2 (for example, converting game points into dollars for donation).

Furthermore, as depicted in FIG. 1, the public welfare donation system of the present invention additionally incorporates a display statistics module 7 signally connected to the distribution record module 6. This module is used to display the donation records 101 generated by the distribution record module 6, and to summarize the public welfare donations 63. When the cumulative total of the public welfare donations 63 reaches a specific threshold value 71 (for example, 1 million dollars), a notification message 72 is displayed (such as an instant congratulatory announcement, accompanied by fireworks animation). Additionally, when the cumulative total of the public welfare donations 63 reaches 5 million dollars, besides the instant congratulatory announcement, the notification message will also display an animation of a rain of gold coins, and so forth, to incentivize and encourage donations.

Furthermore, as depicted in FIG. 1, the display statistics module 7 can also have the functionality to summarize the amounts within the donation records 101 generated by the distribution record module 6. When the accumulated amount reaches a specific individual threshold value 73 (for example, when the total donation value reaches $100,000), the first user 1 transitions from an original identity recognition 102 (such as a new membership level) to a new identity recognition 103 (such as level one membership). This transition is presented to the first user 1 through a notification message 72, for example, using audiovisual or animated means, illustrating the journey of the first user 1 from the original identity recognition 102 to the new identity recognition 103 (for example, from a tiny seedling of charity growing into a sapling of charity, and further growing step by step into a robust tree of charity), aiming to inspire and encourage donations.

In addition to the embodiments mentioned above, the public welfare donation system of the present invention can also include a verification module 8 signally connected to the database 3 and the distribution record module 6. This module is responsible for auditing 81 the execution of the public welfare donations 63 and verifying the donation records 101 to ensure the proper implementation of the public welfare donations 63. The verification module 8 can conduct daily reconciliation operations (for example, summarizing at 23:30 each day), record all charitable activities in the public welfare donation system, reconcile the donation amounts, and allow each beneficiary organization to verify whether the individual donation amounts match the total donation amounts in their accounts. Subsequently, after verification by the beneficiary organizations and confirmation of no discrepancies, the public welfare donation system of the present invention transfers the funds to the beneficiary organizations' accounts according to the agreed-upon times and dates, and notifies them of the donation transfer. Furthermore, the verification module 8 includes a query unit 82 for the first user 1 to publicly inquire about the execution status of the public welfare donations 63. Through this query unit 82, anyone on the system can transparently examine the execution status of each donation, ensuring that the flow of funds is open and transparent and can withstand scrutiny.

Finally, the public welfare donation system disclosed by the present invention can integrate the following concepts to be implemented in the field of public welfare:

Example one is to extract and collect various data about the characteristics of donors (i.e., first user 1) such as donor information, donor behavioral analysis, donor preferences, donation data, etc.

Example two is that, after completing the initial data collection of donors (i.e., first user 1), further analysis can be conducted on this data to gain insights into the intentions of donors (i.e., first user 1) and trends in the relevant market, thereby initiating a series of strategies and plans related to public welfare donations.

Example three is that precise targeting of public welfare advertisements and 24-hour automated processing can be achieved, eliminating the need to worry about manpower or lack of internet expertise.

Example four is that the rich donation themes on the public welfare donation system disclosed by the present invention can be automatically recommended to donors, eliminating the need for sending newsletters, printing journals or EDM, or searching for advertising space, which consume manpower. The present invention's system will automatically and instantly recommend suitable charitable packages and content related to charitable issues of interest.

Example five is that, for donors with fewer donation instances, re-marketing initiatives can be launched to remind them of the time since their last donation, aiming to achieve segmented fundraising for different social issues.

Furthermore, the display statistics module 7 of the public welfare donation system disclosed by the present invention can have the capability to analyze the first member record 10 stored in the database 3 related to the first user 1 and analyze the donation information 12 sent by the first user 1. This provides accurate public welfare advertisements tailored to the donation intentions and behaviors of the first user 1 and sends reminders to the first user 1 about the time interval since their last donation to encourage them to donate again.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A public welfare donation system, comprising:
a database storing a first member record and a first donation target;
a registration and authentication module signally connected to the database, which receives a login request from a first user, compares the login request with the first member record of the database, and approves the login request if the login request matches the first member record;
a donation operation module signally connected to the registration and authentication module, which produces a donation information from the first user approved by the registration and authentication module; and
a distribution record module signally connected to the donation operation module, and the database, which performs a cross-checking operation on the donation information against the first donation target, executes a public welfare donation to the first donation target based on the donation information if the cross-checking operation is successful, generates a donation record, and updates first member record with the donation record.

2. The public welfare donation system according to claim 1, further comprising a display statistics module signally connected to the distribution record module, which displays the donation records generated by the distribution record module, summarizes the public welfare donations, and displays a notification message when a first cumulative total of the public welfare donations reaches a specific threshold value.

3. The public welfare donation system according to claim 2, wherein the display statistics module further summarizes a second cumulative total within the donation records generated by the distribution record module, transitions the first user from an original identity recognition to a new identity recognition when the second cumulative total reaches a specific individual threshold value, and notifies the first user through the notification message through an audiovisual means, illustrating a journey of the first user from the original identity recognition to the new identity recognition.

4. The public welfare donation system according to claim 1, wherein the first donation target comprises information about a first recipient unit; and the donation information comprises information about the first recipient unit, a donation period, and a donation amount.

5. The public welfare donation system according to claim 1, wherein the first donation target comprises information about a first charity sale, a designated recipient unit corresponding to the first charity sale, and donation details; and
the donation information comprises a consent and authorization instruction for the first donation target.

6. The public welfare donation system according to claim 1, wherein the first donation target comprises information about a first recipient unit and a first fundraising event; the first fundraising event comprises at least one of the following events: photography, creation, singing, talent, performance, audiovisual playback, or speech; and the donation information comprises a consent and authorization instruction for the first donation target.

7. The public welfare donation system according to claim 4, wherein the first donation target is presented to the first user in a coded barcode via a handheld device of the first user so that the first user reads information of the first recipient unit; the donation information comprises the first recipient unit and a donation amount; and the donation information is sent back to the distribution record module via the handheld device for the cross-checking operation.

8. The public welfare donation system according to claim 1, further comprising an interactive module signally connected to the donation operation module and the distribution record module, which allows the first user to participate in a first interactive content bound to the first donation target; wherein, when the first user participates in the first interactive content and wins, the first user receives at least one reward, and selectively donates the at least one reward through the distribution record module based on the donation information.

9. The public welfare donation system according to claim 1, further comprising a verification module signally connected to the database and the distribution record module, which audits the public welfare donations' execution and verifies the donation records to ensure proper implementation of the public welfare donation; wherein the verification module comprises a query unit for the first user to publicly inquire about an execution status of the public welfare donation.

10. The public welfare donation system according to claim 1, wherein the display statistics module further analyzes the first member record stored in the database related to the first user and the donation information sent by the first user to provide accurate public welfare advertisements tailored to the first user's donation intentions and behaviors and to send reminders to the first user about a time interval since last donation to encourage the first user to donate again.

11. The public welfare donation system according to claim 2, wherein the first donation target comprises information about a first recipient unit; and the donation information comprises information about the first recipient unit, a donation period, and a donation amount.

12. The public welfare donation system according to claim 3, wherein the first donation target comprises information about a first recipient unit; and the donation information comprises information about the first recipient unit, a donation period, and a donation amount.

13. The public welfare donation system according to claim 2, wherein the first donation target comprises information about a first charity sale, a designated recipient unit corresponding to the first charity sale, and donation details; and
the donation information comprises a consent and authorization instruction for the first donation target.

14. The public welfare donation system according to claim 3, wherein the first donation target comprises information about a first charity sale, a designated recipient unit corresponding to the first charity sale, and donation details; and the donation information comprises a consent and authorization instruction for the first donation target.

15. The public welfare donation system according to claim 2, wherein the first donation target comprises information about a first recipient unit and a first fundraising event; the first fundraising event comprises at least one of the following events: photography, creation, singing, talent, performance, audiovisual playback, or speech; and the donation information comprises a consent and authorization instruction for the first donation target.

16. The public welfare donation system according to claim 3, wherein the first donation target comprises information about a first recipient unit and a first fundraising event; the first fundraising event comprises at least one of the following events: photography, creation, singing, talent, performance, audiovisual playback, or speech; and the donation information comprises a consent and authorization instruction for the first donation target.

17. The public welfare donation system according to claim 6, wherein the first donation target is presented to the first user in a coded barcode via a handheld device of the first user so that the first user reads information of the first recipient unit; the donation information comprises the first recipient unit and a donation amount; and the donation information is sent back to the distribution record module via the handheld device for the cross-checking operation.

18. The public welfare donation system according to claim 2, further comprising an interactive module signally connected to the donation operation module and the distribution record module, which allows the first user to participate in a first interactive content bound to the first donation target; wherein, when the first user participates in the first interactive content and wins, the first user receives at least one reward, and selectively donates the at least one reward through the distribution record module based on the donation information.

19. The public welfare donation system according to claim 3, further comprising an interactive module signally connected to the donation operation module and the distribution record module, which allows the first user to participate in a first interactive content bound to the first donation target; wherein, when the first user participates in the first interactive content and wins, the first user receives at least one reward, and selectively donates the at least one reward through the distribution record module based on the donation information.

20. The public welfare donation system according to claim 2, further comprising an interactive module signally connected to the donation operation module and the distribution record module, which allows the first user to participate in a first interactive content bound to the first donation target; wherein, when the first user participates in the first interactive content and wins, the first user receives at least one reward, and selectively donates the at least one reward through the distribution record module based on the donation information.

21. The public welfare donation system according to claim 3, further comprising an interactive module signally connected to the donation operation module and the distribution record module, which allows the first user to participate in a first interactive content bound to the first donation target; wherein, when the first user participates in the first interactive content and wins, the first user receives at least one reward, and selectively donates the at least one reward through the distribution record module based on the donation information.
